(19) United States
(12) Patent Application Publication
(10) Pub. No.: US 2026/0241757 A1
(43) Pub. Date: Aug. 20, 2026

(54) TOWING HOOK ASSEMBLY AND METHOD

(71) Applicant: BRINK TOWING SYSTEMS B.V., Staphorst (NL)

(72) Inventor: Léon NIJMEIJER, De wijk (NL)

(73) Assignee: BRINK TOWING SYSTEMS B.V., Staphorst (NL)

(21) Appl. No.: 19/161,135

(22) PCT Filed: Apr. 11, 2024
(86) PCT No.: PCT/EP2024/059868

§ 371 Date: Aug. 29, 2025

(30) Foreign Application Priority Data
Apr. 14, 2023 (NL) 2034574

(51) Int. Cl. B60D 1/18; B60D 1/06; B60D 1/28

(52) U.S. Cl. CPC B60D 1/187; B60D 1/06; B60D 1/28

(57) ABSTRACT

A towing hook assembly comprising a towing hook having a proximal end for attachment to a vehicle and a distal end comprising a towing ball. The towing hook has a neck portion extending along a longitudinal axis from the proximal end to the distal end. The towing hook has an operational position in which the longitudinal axis lies in a vertical plane, the vertical plane bisecting the neck portion into a first lateral side and a second lateral side. The towing hook assembly further comprises a receiver arrangement for the attachment of one or more trailer safety chains to the towing hook assembly. The receiver arrangement comprises two fastening loops, located on opposite sides of the longitudinal axis. The two fastening loops are constituted by a first mounting plate having a first receiving opening and a second mounting plate having a second receiving opening. The receiver arrangement is releasably attached to the neck portion of the towing hook.

### TECHNICAL FIELD

The present invention relates to a towing hook assembly for use with trailers having safety chains. The invention further relates to a method of providing a neck portion of a towing hook with a receiver arrangement for the attachment of one or more safety chains.

### BACKGROUND

In various countries such as the United States of America, Canada, Australia and New Zealand, legislation dictates that trailer safety chains must be used when towing a trailer. For example, in Australia, trailers under 2500 kg ATM (Aggregate Trailer Mass) must be fitted with at least one safety chain and trailers over 2500 kg ATM must be fitted with two chains. The safety chain(s) must be permanently attached to the trailer and releasably connectable to the towing vehicle. Generally, the releasable connection to the towing vehicle is attained by providing the towing hook on the towing vehicle with integrated safety loops to which shackles or hooks connected to the safety chains can be attached. In this respect, reference is made to CN 109986917 A.

The provision of integrated safety loops can increase the production costs of a towing hook and, for retractable towing hooks, may require more stowage space when retracted.

It is therefore an object of the present invention to provide a towing hook assembly which includes a towing hook that can conveniently be adapted for use on markets requiring safety chains.

### SUMMARY

In accordance with the present invention, the above object may be attained by the provision of a towing hook assembly that comprises a towing hook having a proximal end for attachment to a towing vehicle and a distal end comprising a towing ball. The towing hook has a neck portion extending along a longitudinal axis from the proximal end to the distal end. The towing hook has an operational position in which the longitudinal axis lies in a vertical plane. The vertical plane bisects the neck portion into a first lateral side and a second lateral side. The towing hook assembly further comprises a receiver arrangement for the attachment of one or more trailer safety chains to the towing hook assembly. The receiver arrangement comprises two fastening loops located on opposite sides of the longitudinal axis. The two fastening loops are constituted by a first mounting plate having a first receiving opening and a second mounting plate having a second receiving opening. The receiving openings may be formed by cutting material out of the mounting plates. The receiver arrangement is releasably attached to the neck portion of the towing hook.

Since the receiver arrangement is releasably attached to the neck portion of the towing hook, the towing hook assembly complies with legislation pertaining to the use of safety chains when the receiver arrangement is attached to the towing hook. On the other hand, in countries that do not demand the use of safety chains, the receiver arrangement can be omitted or removed.

The receiver arrangement may be releasably attached to the neck portion of the towing hook by means of a plurality of bolts. The bolts may be through bolts secured using nuts, for example locking nuts. Alternatively, blind bolts may be used.

In an embodiment, each bolt of the plurality of bolts passes through the first mounting plate, the neck portion and said second mounting plate.

Preferably, when the receiver arrangement is attached to the towing hook, the first and second receiving openings are coaxial. This provides for a compact arrangement, with the width of the towing hook assembly being only slightly greater than that of the neck portion at the position of the receiver arrangement on the neck portion.

In an embodiment, the first and second mounting plates are separate mounting plates. Alternatively, the receiver arrangement may be substantially U-shaped, with the U-shape being constituted by the first and second mounting plates being connected by a bridging member. The bridging member may be adapted to contact the neck portion of the towing hook, thereby contributing to the ease of handling of the receiver arrangement and its stability when attached to the towing hook. In one embodiment, the first and second mounting plates and the bridging member may form a unitary component, for example a forged component.

In an embodiment, the towing hook assembly further comprises an electrical connector socket. The electrical connector socket may be arranged on the neck portion of the towing hook, for example within a through-hole of the neck portion. The receiver arrangement can be releasably attached to the neck portion of the towing hook at a location between the proximal end of the towing hook and the electrical connector socket. In this manner, the fastening loops may be closer to the proximal end of the towing hook than to the towing ball. Due to the proximity of the fastening loops to the attachment of the towing hook to the towing vehicle, any forces imparted by the safety chains to the towing hook will create a relatively small moment about the attachment.

The first and second receiving openings in the first and second mounting plates may be located on a side of the towing hook opposite to the towing ball. Thus, in the operational position of the towing hook, the receiving openings are located below the neck portion of the towing hook. This can make the receiving openings readily accessible when attaching the safety chains to the receiver arrangement.

In an embodiment, the towing hook assembly further comprises a first shackle and a second shackle. The first and second shackles are adapted to receive a first safety chain and a second safety chain, respectively. The first and second shackles are adapted to attach the first and second safety chains to the receiver arrangement. Preferably, the first and second shackles are D-shackles each comprising a U-shaped bow and a threaded pin. The threaded pin has a diameter allowing the pin to pass through either of the first and second receiving openings in the mounting plates. When the safety chains are connected to the receiver arrangement, the threaded pin is adapted to extend in a direction perpendicular to the longitudinal axis.

A further aspect of the invention pertains to a method of providing a neck portion of a towing hook with a receiver arrangement for the attachment of one or more trailer safety chains to a towing hook assembly. The neck portion has a first lateral side and a second lateral side, and the receiver arrangement comprises two fastening loops. The method comprises the steps of:
providing the towing hook and the two fastening loops, and
attaching a first of the two fastening loops to the first lateral side of the neck portion and a second of the two fastening loops to the second lateral side of the neck portion, the attaching being attained using a plurality of bolts such that the receiver arrangement is releasably attached to the neck portion of the towing hook.

### BRIEF DESCRIPTION OF THE DRAWINGS

Various embodiments of the invention will be described in greater detail by way of example only with reference to the appended drawings, in which:

FIG. 1 is a perspective view of an exemplary embodiment of a towing hook assembly in accordance with the present invention;

FIG. 2 is an exploded view of the towing hook assembly of FIG. 1;

FIG. 3 is a side view of a fastening loop forming a part of the towing hook assembly of the present invention;

FIG. 4 is a perspective view of a receiver arrangement according to an embodiment of the invention;

FIG. 5 is a side view of a neck portion of a towing hook which may form part of a towing hook assembly according to the present invention, and

FIG. 6 is a perspective view of a shackle for use with the receiver arrangement.

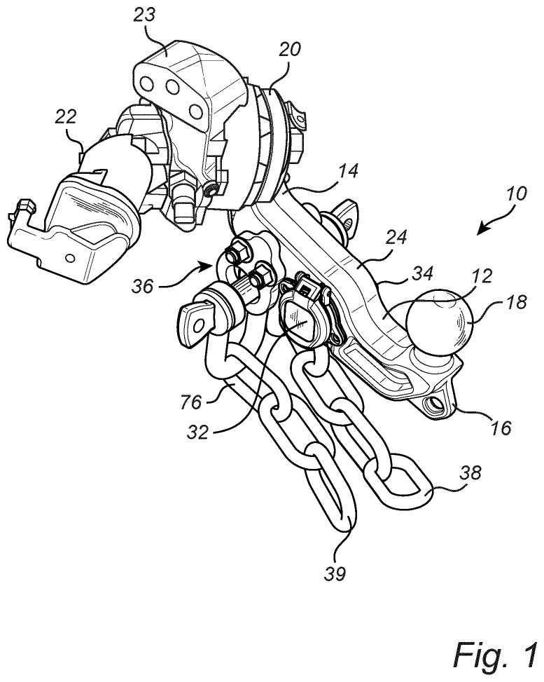

### DETAILED DESCRIPTION

In the drawings, reference number 10 denotes a towing hook assembly according to the present invention. The towing hook assembly comprises a towing hook 12 having a proximal end 14 for attachment to a towing vehicle and a distal end 16 comprising a towing ball 18 to which a trailer coupler of a trailer (not shown) may be attached.

In the illustrated embodiment, the towing hook assembly 10 is of the retractable type such that the towing hook 12 may be displaced from a (not shown) stowed position, in which it is stored beneath a rear section of the towing vehicle, to an operational position in which a trailer coupler may be attached to the towing ball 18. Thus, the proximal end 14 of the towing hook 12 is connected to a displacement assembly 20 driven by an electric motor 22. A support bracket 23 carries the displacement assembly 20 and the electric motor 22 and serves to mount the displacement assembly 20 and electric motor 22 to a (not shown) cross beam of the towing vehicle. Nevertheless, it is to be understood that the towing hook assembly 10 may be of the type which is permanently fixed to the vehicle in its operational position, or which is detachable.

Irrespective of the type of towing hook assembly, the towing hook 12 has a neck portion 24 extending along a longitudinal axis 26 from the proximal end 14 to the distal end 16 of the towing hook 12. In the illustrated operational position of the towing hook 12, the longitudinal axis 26 lies in a vertical plane which bisects the neck portion 24 into a first lateral side 28 and a second lateral side 30.

Optionally, the towing hook assembly 10 may further comprise an electrical connector socket 32 for receiving an electrical plug (not shown) of the trailer's electrical system. In the illustrated embodiment, the electrical connector socket 32 is arranged on the neck portion 24 of the towing hook 12 approximately midway along the neck portion. The neck portion 24 may be provided with a through opening 34 to accommodate the electrical connector socket 32 within the neck portion.

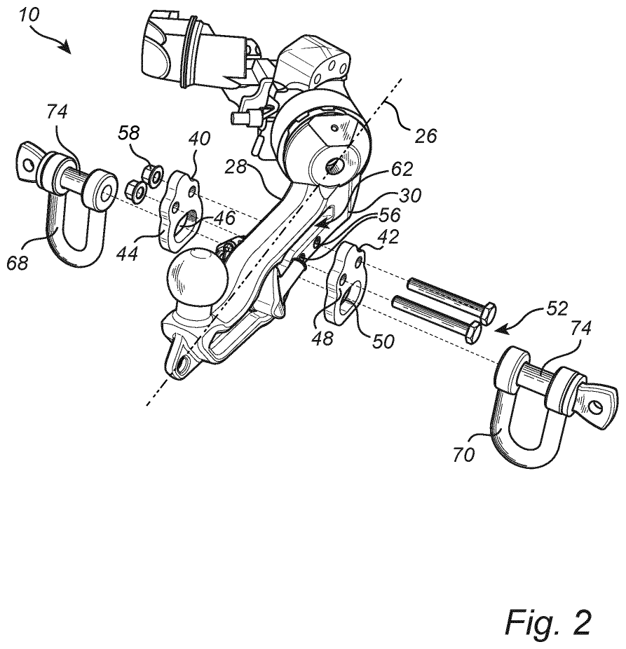

In accordance with the present invention, the towing hook assembly 10 comprises a receiver arrangement 36 for the attachment of one or more trailer safety chains 38, 39 to the towing hook assembly 10, with the receiver arrangement 36 comprising two fastening loops 40, 42, located on opposite sides of the longitudinal axis 26, the receiver arrangement 36 being releasably attached to the neck portion 24 of the towing hook 12. As is perhaps most clearly derivable from FIG. 2, the two fastening loops 40, 42 of the receiver arrangement 36 are constituted by a first mounting plate 44 having a first receiving opening 46 and a second mounting plate 48 having a second receiving opening 50.

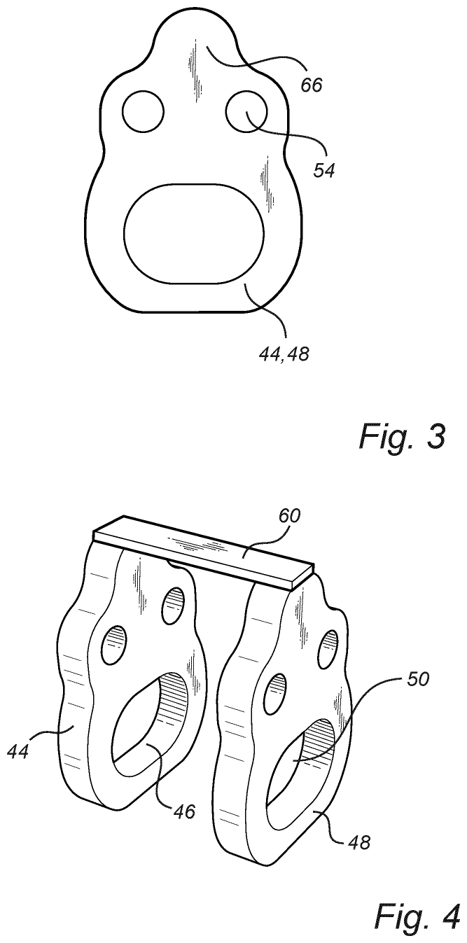

In one embodiment, the receiver arrangement 36 is releasably attached to the neck portion 24 of the towing hook 12 by means of a plurality of bolts 52. With reference to FIG. 3, each mounting plate 44, 48 may be provided with a pair of bolt holes 54. The bolt holes are arranged to be aligned with a corresponding pair of through holes 56 formed in the neck portion 24 of the towing hook 12. The through holes 56 extend essentially perpendicular to the longitudinal axis 26 of the neck portion 24 from the first lateral side 28 to the second lateral side 30. To attach the receiver arrangement to the neck portion of the towing hook, each bolt 52 of the plurality of bolts is passed through a respective bolt hole 54 in the first mounting plate 44, a respective through hole 56 in the neck portion 25 and a respective bolt hole 54 in the second mounting plate 48. Each bolt 52 may then be secured with a nut 58, for example a locking nut. Once the receiver arrangement 36 has been attached to the towing hook 12, the first and second receiving openings 46, 50 are coaxial.

In the embodiments described above, the first and second mounting plates 46, 50 are separate mounting plates. In an alternative embodiment illustrated in FIG. 4, the receiver arrangement 36 is substantially U-shaped, with the U-shape being constituted by the first and second mounting plates 46, 50 being connected by a bridging member 60. Preferably, the first and second mounting plates 46, 50 and the bridging member 60 form a unitary component. The bridging member 60 may rest on an upper surface of the neck portion 24 of the towing hook 12, thereby facilitating the attaching of the receiver arrangement 36 to the towing hook. Common to all embodiments is that, when the receiver arrangement 36 is attached to the towing hook 12, the first and second mounting plates 46, 50 extend substantially parallel to the longitudinal axis 26 of the neck portion 24 of the towing hook.

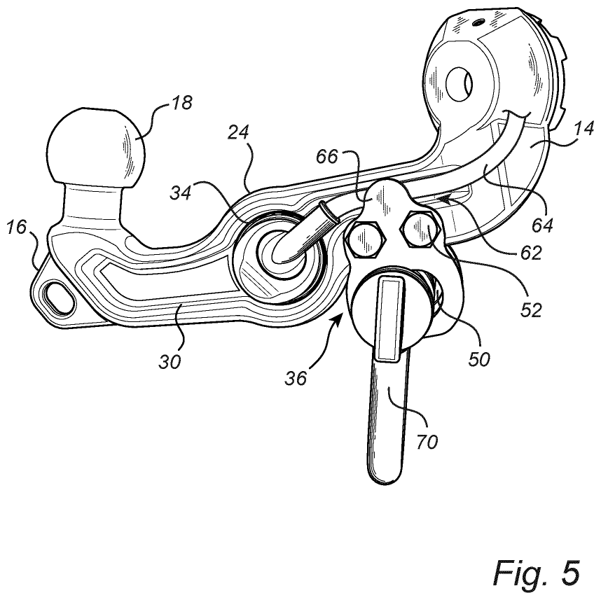

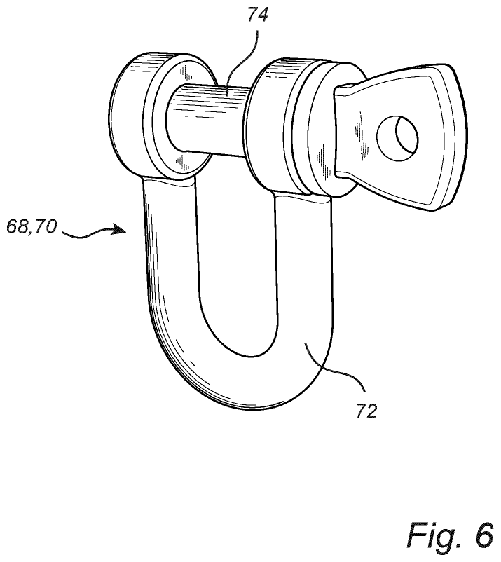

In the illustrated embodiments, the receiver arrangement 36 is attached to the towing hook 12 at a location between the proximal end 14 of the towing hook 12 and the through opening 34 for the electrical connector socket 32. Accordingly, the receiver arrangement 36 is positioned closer to the proximal end 14 than to the distal end 16 of the neck portion 24. On advantage of such an arrangement will be explained in the following with reference to FIG. 5. FIG. 5 illustrates the second lateral side 30 of the neck portion 24. The second lateral side 30 may be provided with a cable channel 62 extending from a position adjacent the proximal end 14 of the neck portion to the through opening 34 accommodating the electrical connector socket 32. The cable channel 62 is formed in the second lateral side 30 such that it passes above the pair of through holes 56 formed in the neck portion 24 of the towing hook 12 as seen when the towing hook is in its operational position. The cable channel 62 is adapted to accommodate an electrical cable 64 for connecting the electrical connector socket 32 to the electrical system of the towing vehicle. To assist in retaining the electrical cable 64 in the cable channel 62, the second mounting plate 48 may have a tongue portion 66 extending in a direction away from the second receiving opening 50. In this manner, when the receiver arrangement 36 is attached to the towing hook 12, the tongue portion 66 of the second mounting plate extends over a region of the cable channel 62 to thereby secure the electrical cable 64 within the cable channel 62. Of course, even though no electrical cable runs along the first lateral side 28 of the neck portion 24 of the towing hook 12, the first mounting plate 44 may also exhibit a similar tongue portion to that of the second mounting plate 48. Indeed, in a preferred embodiment, the first and second mounting plates 44, 48 are identical.

When the receiver arrangement 36 is attached to the towing hook 12, the first and second receiving openings 46, 50 in the first and second mounting plates are located on a side of the towing hook 12 opposite to the towing ball 18. In the operational position of the towing hook 12, the receiving openings 46, 50 are thus located below the neck portion 24 of the towing hook 12. The towing hook assembly 10 further comprises a first shackle 68 and a second shackle 70, the first and second shackles being adapted to receive a first safety chain 38 and a second safety chain 39, respectively. With reference to FIG. 6, the first and second shackles 68, 70 are preferably D-shackles, each comprising a U-shaped bow 72 and a threaded pin 74. The threaded pin 74 has a diameter which allows the threaded pin 74 to pass through either of the first and second receiving openings 46, 50. The U-shaped bow 72 is adapted to pass through an end link 76 of one of the first and second safety chains 38, 39. When the receiver arrangement is 12 is attached to the towing hook 12 and the first and second shackles 68, 70 attach said first and second safety chains 38, 39 to the receiver arrangement, the threaded pins 74 of the shackles 68, 70 extend in a direction substantially perpendicular to the longitudinal axis 26 of the neck portion 24 of the towing hook.

In a preferred embodiment, once a towing operation has been completed, the first and second shackles 68, 70 can be detached from the first and second mounting plates 46, 50, respectively. The towing hook 12 can then be retracted to its stowed position without the need to remove the mounting plates.

The dimensions of the components constituting the towing hook assembly may differ depending on the strength class needed for the towing operation. Typically, each mounting plate 44, 48 may be a steel plate having a thickness of 10 mm. To accommodate a bolt 52 of M10 size, each bolt hole 54 may have a diameter of 10.5 mm. The spacing between the bolt holes 54 will depend on the layout of the through holes 56 formed in the neck portion 24 of the towing hook 12, though may typically be in the order of 27 mm. To facilitate attachment of the shackles 68, 70, the receiving openings 46, 50 may have a long circle shape with dimensions of e.g. 37×26 mm, the longer dimension extending substantially parallel to the longitudinal axis 26 of the neck portion 24 of the towing hook 12.

By providing a kit comprising the receiver arrangement 36, bolts 52 and shackles 68, 70, a towing hook intended for e.g. the European market can be conveniently adapted for use on markets which demand the use of safety chains.

While the above is a complete description of selected embodiments of the invention, the skilled person will appreciate that various modifications and adaptations are possible while still falling within the scope of protection defined by the appended claims. For example, the attachment of the receiver arrangement 36 to the towing hook 12 may be achieved using two or more through bolts, four or more blind bolts or a suitable number of bolts and a form fit shape.

1. A towing hook assembly comprising a towing hook having a proximal end for attachment to a vehicle and a distal end comprising a towing ball, said towing hook having a neck portion extending along a longitudinal axis from the proximal end to the distal end, said towing hook having an operational position in which said longitudinal axis lies in a vertical plane, said vertical plane bisecting said neck portion into a first lateral side and a second lateral side, said towing hook assembly further comprising a receiver arrangement for the attachment of one or more trailer safety chains to said towing hook assembly, said receiver arrangement comprising two fastening loops, located on opposite sides of said longitudinal axis, said two fastening loops being constituted by a first mounting plate having a first receiving opening and a second mounting plate having a second receiving opening, wherein said receiver arrangement is releasably attached to said neck portion of said towing hook.

2. The towing hook assembly according to claim 1, wherein said receiver arrangement is releasably attached to said neck portion of said towing hook by means of a plurality of bolts.

3. The towing assembly according to claim 2, wherein each bolt of said plurality of bolts passes through said first mounting plate, said neck portion and said second mounting plate

4. The towing hook assembly according to claim 1, wherein said first and second receiving openings are coaxial.

5. The towing hook assembly according to claim 1, wherein said first and second mounting plates are separate mounting plates.

6. The towing hook assembly according to claim 1, wherein said receiver arrangement is substantially U-shaped, said U-shape being constituted by said first and second mounting plates being connected by a bridging member.

7. The towing hook assembly according to claim 6, wherein said first and second mounting plates and said bridging member form a unitary component.

8. The towing hook assembly according to claim 1, said towing hook assembly further comprises an electrical connector socket, said electrical connector socket being arranged on said neck portion of said towing hook, said receiver arrangement being releasably attached to said neck portion of said towing hook at a location between said proximal end of the towing hook and said electrical connector socket.

9. The towing hook assembly according to claim 1, wherein said first and second receiving openings in said first and second mounting plates are located on a side of the towing hook opposite to said towing ball.

10. The towing hook assembly according to claim 1, wherein said towing hook assembly further comprises a first shackle and a second shackle, said first and second shackles being adapted to receive a first safety chain and a second safety chain, respectively, said first and second shackles being adapted to attach said first and second safety chains to said receiver arrangement.

11. The towing hook assembly according to claim 10, wherein said first and second shackles are D-shackles each comprising a U-shaped bow and a threaded pin, said threaded pin having a diameter allowing said pin to pass through either of said first and second receiving openings.

12. The towing hook assembly according to claim 11, wherein said threaded pin is adapted to extend in a direction perpendicular to said longitudinal axis.

13. The towing hook assembly according to claim 1, wherein said towing hook assembly, when mounted on a vehicle, is retractable from said operational position to a stowed position.

14. A method of providing a neck portion of a towing hook with a receiver arrangement for the attachment of one or more trailer safety chains to a towing hook assembly, said neck portion having a first lateral side and a second lateral side, and said receiver arrangement comprising two fastening loops, said method comprising the steps of:
providing said towing hook and said two fastening loops and
attaching a first of said two fastening loops to the first lateral side of said neck portion and a second of said two fastening loops to the second lateral side of said neck portion,
said attaching being attained using a plurality of bolts such that said receiver arrangement (36) is releasably attached to said neck portion of said towing hook.
